(19) United States
(12) Patent Application Publication
(10) Pub. No.: US 2026/0316885 A1
(43) Pub. Date: Oct. 15, 2026

(54) EXTERNAL INDICATION OF OPERATING CONDITION

(71) Applicant: Also, Inc., Palo Alto, CA (US)

(72) Inventor: Robert Saul LEIKEN, San Francisco, CA (US)

(21) Appl. No.: 19/177,922

(22) Filed: Apr. 14, 2025

(51) Int. Cl. B62M 6/50; B62J 6/16; B62J 6/26; B62J 50/22

(52) U.S. Cl. CPC B62M 6/50; B62J 6/16; B62J 6/26; B62J 50/22

(57) ABSTRACT

External indications of operations conditions are provided. An electric bike can include an input device to receive a selection of one of various modes of operation for the electric bike. The electric bike can include an output device to provide indications corresponding to the various modes of operation. The electric bike can include an electric motor to propel the electric bike. The electric bike can include and one or more processors, coupled with memory, to, in response to a receipt of the selected mode of operation from the input device, operate the electric motor in the selected mode of operation and cause the output device to output one of the plurality of indications corresponding to the selected mode of operation.

### INTRODUCTION

Vehicles can operate according to various modes of operation, as may correspond to a performance envelope of the vehicle.

### SUMMARY

An electric bike can include an input device to receive a selection of one of various modes of operation for the electric bike. The electric bike can include an output device to provide indications corresponding to the various modes of operation. The electric bike can include an electric motor to propel the electric bike. The electric bike can include and one or more processors, coupled with memory, to, in response to a receipt of the selected mode of operation from the input device, operate the electric motor in the selected mode of operation and cause the output device to output one of the plurality of indications corresponding to the selected mode of operation.

In some aspects, the techniques described herein relate to a system including one or more processors, coupled with memory. The one or more processors can receive, from an input device, a selection of one of a plurality of modes of operation for an electric bike. The one or more processors can compare an operating state of the electric bike to a threshold. The one or more processors can generate a first control signal to limit torque generated by an electric motor of a propulsion system of the electric bike based on the comparison. The one or more processors can generate a second control signal to cause a presentation of the selected mode of operation to a non-rider of the electric bike.

A method can include detecting, by one or more processors and memory coupled with a bike, a selected operating mode of a plurality of operating modes. The method can include, responsive to the detection, generating a first control signal to limit an output of a propulsion system of the bike and a second control signal to cause a presentation of the selected mode of operation using a taillight or headlamp of the bike.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 is a block diagram for an example of a data processing system, according to some aspects.

FIG. 2 depicts an example of an electric bike including the data processing system, according to some aspects.

FIGS. 3A and 3B depict detailed views of an example of an electric bike, according to some aspects.

FIG. 4 depicts a flow diagram for an example of a method of electric bike operation, according to some aspects.

FIG. 5 depicts a block diagram illustrating an architecture for a computer system that can be employed to implement elements of the systems and methods described and illustrated herein.

### DETAILED DESCRIPTION

Following below are more detailed descriptions of various concepts related to, and implementations of, methods, apparatuses, and systems of a perception system for environmental visualization. The various concepts introduced above and discussed in greater detail below may be implemented in any of numerous ways.

The present disclosure relates to control systems for electric bikes. The control systems can include circuity to control a propulsion system in various modes of operation. For example, the various modes of operation can include a first mode for pedal-assisted operation below a threshold speed. The first mode of operation can inhibit throttle-based operation of the electric bike. The throttle can refer to any input, other than the pedals, to modulate an output of an electric motor of the electric bike, such as a handle-bar mounted throttle lever. A second mode of operation can permit throttle-based operation. A third mode of operation can permit operation above the threshold speed. Electric bikes can implement further modes of operation, such as fourth or fifth modes, and so on. The electric bike can include an input device, actuatable by a rider, to transition between the various modes of operation. Moreover, the electric bike can automatically determine modes of operation responsive to a determination of a location (e.g., based on location data, as may be determined based on a global positioning system (GPS) sensor). The electric bike can display, or automatically transition between, modes of operation based on the determination of the location.

The first, second, and third modes of operation can be referred to herein as class I, II, and III operation. Some locations, such as parks or bike paths, permit operation of electric bikes for some classes but not others. However, it can be difficult to align compliance with restrictions for electric bikes capable of operating in multiple modes of operation. For example, it can be challenging for a rider of the electric bike to determine what class of operation is permitted within an area. Moreover, it can be challenging for other road users to determine compliance of the rider with any restrictions. According to the present disclosure, one or more visual or other indicators (e.g., a taillight) can indicate a selected mode of operation to a non-rider of the bike.

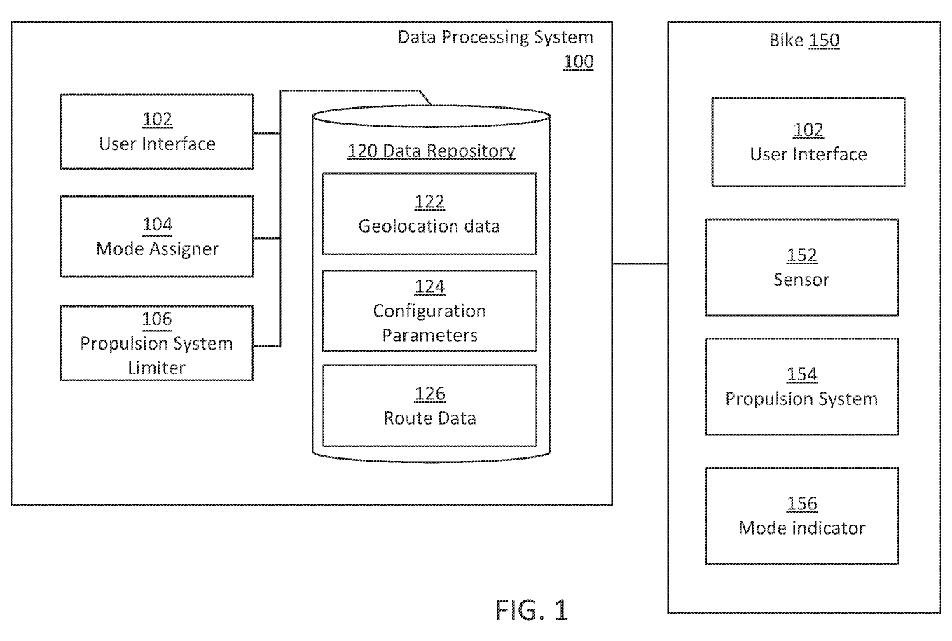

FIG. 1 depicts a data processing system 100 to indicate a mode of operation of an electric bike 150, in accordance with some aspects. The data processing system 100 can include, interface with, or be a part of (e.g., be integral to a control system of) the electric bike 150. The data processing system 100 can include or interface with a user interface 102 to receive a selection of an operating mode. The data processing system 100 can include or interface with a mode assigner 104 to assign an operating mode (e.g., the selected mode) to the electric bike. The data processing system 100 can include or interface with various sensors 152 to determine a location associated with the electric bike. The data processing system 100 can include or interface with at least one propulsion system limiter 106 to limit an output of a propulsion system 154 based on the assigned mode of operation. With further reference to the user interface 102, the data processing system 100 can include one or more mode indicators 156 to indicate the assigned mode of operation.

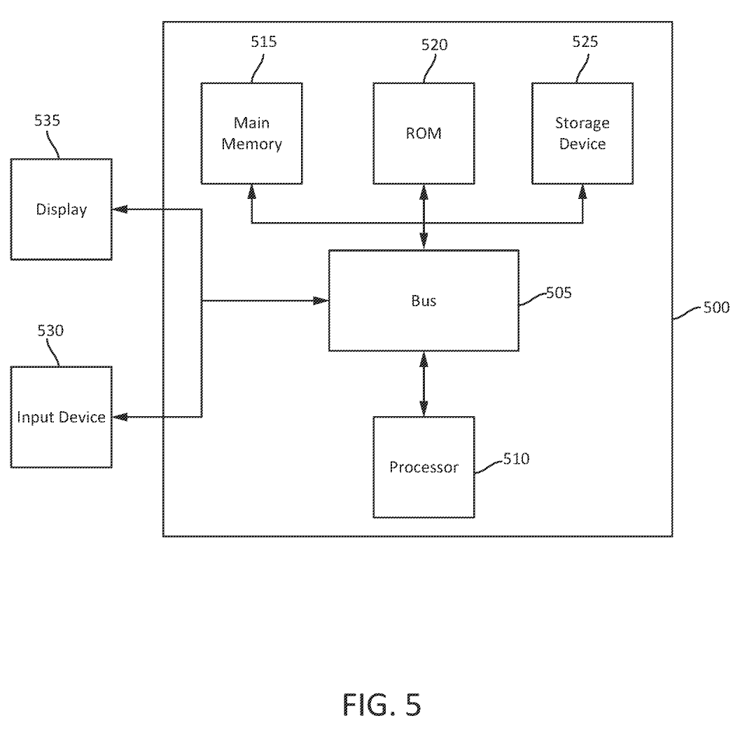

The data processing system 100 can include at least one data repository 120. The user interface 102, mode assigner 104, and propulsion system limiter 106 can each include at least one processing unit or other logic device such as programmable logic array engine, or module configured to communicate with the data repository 120 or database. The user interface 102, mode assigner 104, and propulsion system limiter 106 can be separate components, a single component, or part of the data processing system 100. The data processing system 100 can include hardware elements, such as one or more processors, logic devices, or circuits. For example, the data processing system 100 can include one or more components or structures of functionality of computing devices depicted in FIG. 5.

The data repository 120 can include one or more local or distributed databases, and can include a database management system. The data repository 120 can include computer data storage or memory and can store one or more data structures, such as a data structure corresponding to geolocation data 122, configuration parameters 124, or route data 126.

Geolocation data 122 can refer to or include information related to one or more routes or areas. For example, the geolocation data 122 can include a geofence corresponding to a protected areas or preserve, as can include national or other parks, monuments, or so forth. The routes or areas can correspond to an operating mode of an electric bike 150. For example, some protected areas can prohibit all electric-assisted operation of an electric bike, or permit some modes of electric-assisted operation (e.g., class 1 e-bike operation) but prohibit other modes of operation (e.g., class II or III operation). The geolocation data 122 can correspond to other routes corresponding to modes of operation. For example, the geolocation data 122 can identify various bike routes, as can include roadways, shared use bike or pedestrian routes, or dedicated bike routes. The geolocation data 122 can further include one or more authorized or prohibited modes of operation associated with various geofences routes or areas.

Configuration parameters 124 can refer to or include various settings received from a user interface 102. For example, the configuration parameters 124 can include any information received by the data processing system 100 to alter a mode assigned or presented by the electric bike 150. Various of the configuration parameters 124 can be received from a mobile device operatively coupled with the electric bike (e.g., via a Bluetooth, Wi-Fi, or cellular connection). Configuration parameters 124 can be received from a remote server. The remote server can provide configuration parameters 124 received from a user account to the data processing system 100 (e.g., can relay configuration parameters 124 from a mobile application or web browser). The configuration parameters 124 can include a default state, such that upon non-receipt of a contrary configuration parameter 124, the electric bike 150 can operate according to any of the states described herein or otherwise. For example, a reference to receiving a configuration parameter 124 to activate a feature can refer to an instance in which the feature is either activated or deactivated by default.

Route data 126 can refer to or include a current or planned route of the electric bike 150. The route data 126 can be received from a mobile application, web server, or other device including various aspects of the user interface 102 (e.g., via control elements of a mobile applications interface). The route data 126 can include an indication of a planned route for the electric bike 150. For example, the route data can include a route presented to the user via a navigation system, as can include a navigation system of the electric bike 150 or a mobile device communicatively coupled with the data processing system 100.

The data processing system 100 can include at least one user interface 102 designed constructed, or operational to interface with a user. For example, the user interface 102 can receive a selection of one of various modes of operation for the electric bike 150. The selection can be received by a switch actuatable by a rider of the electric bike 150. For example, the switch can be actuatable via a mechanical switch (e.g., a toggle switch, lever, or pushbutton), touch screen display selection, or other control accessible to a rider seated on a saddle of the electric bike 150. The user interface 102 can include various further input devices, such as inputs received from a mobile application or web browser of a mobile device, to receive the selection of the mode of operation (e.g., as a configuration parameter 124).

The user interface 102 can provide various indications corresponding to the various selectable mode of operation. For example, the user interface 102 can include a mode indicator 156 of (e.g., integral to) the electric bike 150 to provide the indication. Each of the indications can map to at a mode of operations, such as a different visual indicator (e.g., green light for class I operation, a yellow light for class 2 operation, and a red light for class III operation).

A particular indication can vary according to an implementation of one or more mode indicators 156. Some mode indicators can include visual mode indicators, such as LEDs or display panels. For example, a mode indicator 156 can be implemented as a visual indicator, such as a front, rear, or downfacing light. The visual indicator can be positioned for viewing by a non-rider of the electric bike 150, such that pedestrians observing the electric bike 150 can distinguish between the various indications corresponding to the various modes of operation (e.g., a pedestrian can readily distinguish between a blue and yellow LED, various blinking patterns, or other visual indications). At least one mode indicator 156 can provide an indication of the selected mode to a rider of the electric bike 150. The mode indicator 156 for the rider and non-rider can be provided separately (e.g., via a rider facing display and a second display for a non-rider), or according to a same output (e.g., a downward facing light visible to a rider and non-rider). The mode indicator 156 can include various display types, such as visual displays, acoustic outputs, radio frequency (RF) outputs, or so forth. The mode indicator 156 can be configured to emit the indication of the selected operating mode continuously (e.g., in the case of a colored LED), periodically (e.g., in the case of a flashing pattern) or RF broadcast signal, or in response to a polling event, as can be initiated by a rider or non-rider (e.g., an RF response to a request for operating mode).

The data processing system 100 can include at least one mode assigner 104 designed constructed, or operational to assign a selected mode of operation to the propulsion system limiter 106. For example, the mode assigner 104 can receive a selection of one of the various operating modes from the input device. In response to the received selection, the mode assigner 104 can provide the selection to the propulsion system limiter 106 to cause the propulsion system limiter 106 to operate an electric motor of the propulsion system 154 in the selected mode of operation. In response to the received selection, the mode assigner 104 can cause the mode indicator 156 to output the indication corresponding to the selected mode.

The mode assigner 104 can assign modes differing from a selection of an input device, in some cases. For example, the mode assigner 104 can determine that a location of the bike is proximal to or overlapping with a route or area of the geolocation data 122 associated with an operating restriction. In response to determining the mode of operation associated with the location of the electric bike 150, the mode assigner 104 can automatically select the determined mode of operation. Such an operation can aid a rider of an electric bike 150 to conform to any changing operating restrictions along a route. For example, a rider may operate in one mode of operation along a bike path, and transition to operating in a second mode of operation while off-road mountain biking in a designated area according to the automatic selection. Moreover, upon a return to a designated trail, the mode assigner 104 can determine a mode of operation associated with the trail, even where the rider may not have passed by signage detailing any restrictions to modes of operation, aiding the rider to avoid inadvertently violating the bypassed signage.

The data processing system 100 can receive a selection of configuration data to disable the automatic selection, as may aid a rider who encounters mismatches between local rules and modes of operation stored in the geolocation data 122 (or who otherwise does not wish to use the automatic selection). For example, the configuration parameters 124 can include a setting for the automatic selection. The user interface 102 can provide an indication of an impending or concurrent change to a mode of operation associated with a location. For example, when moving from a class II area to an unrestricted area (or vice versa), the mode assigner 104 can cause the user interface 102 to provide an indication of the change. The mode assigner 104 can receive route data 126 such as a user indicated route, or a prediction based on a path of travel (e.g., moving along a bike path). The mode assigner 104 can used the route data to associate the electric bike 150 with a location having an operating restriction prior to entering a geofenced region corresponding to a (restricted) mode of operation. The mode assigner 104 can cause the user interface 102 to provide, prior to entering the geofenced region, an indication corresponding to the mode of operation. For example, if a user is approaching geofenced region, the data processing system 100 can provide the indication to prompt the rider to prepare for another mode of operation, select the mode of operation, or select an alternate route to avoid a restriction on a mode of operation.

An indication of a change to an operating mode associated with the location of the electric bike 150 can be provided along with or separately from an automatic transition between operating modes. For example, according to a selected configuration parameter 124, the mode assigner 104 can (i) cause the mode of operation to automatically change along with presenting an indication of the change, (ii) cause the mode of operation to automatically change without providing the indication of the change, (iii) not cause the mode of operation to automatically change but provide the indication of the change (e.g., as may prompt the rider to manually adjust the mode of operation), or (iv) neither cause the mode of operation to automatically change nor present any indication of the change.

According to a receipt of a corresponding configuration parameter 124, the mode assigner 104 or the user interface 102 can mask (or present) selected notifications to a user. For example, according to a configuration parameter 124, the data processing system 100 can mask indications of a change in an operating mode which have not been received from an input device (e.g., have not been received from a user). For example, if a user selects class I operation, the data processing system 100 can mask restrictions associated with transitions from class III to class II operation, or transitions from class II to class I operation. The data processing system 100 can mask indications of changes related to a class of operation from a more-to less restrictive mode of operation (as can further be based on a currently selected mode of operation). The data processing system 100 can mask indications of changes which will not result in active limiting by the propulsion system limiter 106. For example, if a user is in a mode of operation which does not restrict throttle-based operation, but is not currently using the throttle, an indication of a change to a mode of operation which restricts the throttle can be masked. The mask, or another mask can further depend on a trailing time period, such as thirty seconds or five minutes (e.g., responsive to detecting that the throttle has not been used in a previous five minutes, the data processing system 100 can mask an indication of a transition to a mode which restricts throttle-based operation).

The data processing system 100 can include at least one propulsion system limiter 106 designed, constructed, or operational to limit the operation of a propulsion system 154 of an electric bike 150. For example, the propulsion system limiter 106 can be configured to inhibit propulsion based on a throttle input, limit propulsion based on a throttle input according to a speed of the electric bike 150, or limit a pedal-based propulsion based on a speed limit or effort multiplier. To limit the propulsion, the propulsion system limiter 106 can operatively decouple an input of a throttle level, determine control parameters based on look-up tables or other mappings associated with various modes of operation, or so forth. The propulsion system limiter 106 can adjust control signals on a request for power, or inhibit an output of a battery, inverter, or electric motor itself to limit power output. Such limiting need not inhibit speeds achieved without electrified portions of a propulsion system (e.g., a rider vigorously peddling or coasting downhill can reach speeds that may be violative of a mode of operation when achieved using an electric motor of the propulsion system 154).

The propulsion system limiter 106 can manage transitions between operating modes. For example, the propulsion system limiter 106 can slew a torque output of the electric motor while transitioning between modes of operation, to avoid abrupt or uncomfortable changes observable to the rider. The propulsion system limiter 106 can delay or cancel changes to a mode of operation based on a receipt of a user input from a rider (e.g., an over-ride). For example, a rider summiting a tall hill can defer a transition until reaching a summit, according to an instruction provided using the user interface.

The propulsion system limiter 106 can manage aspects of various modes of operation. For example, the operating modes can include a first mode of operation to inhibit pedal-assisted operation of the electric motor above a first speed and inhibit throttle-controlled operation of the electric motor below the first speed (e.g., prohibit all throttle-based operation). The operating modes can include a second mode of operation to permit throttle-controlled operation of the electric motor below a threshold speed (e.g., the first speed of the first mode of operation). The operating modes can include a third mode of operation to permit pedal-assisted operation of the electric motor above the first speed. For example, such a mode can permit or inhibit the use of the throttle, or separate modes can be provided mapped to use and non-use of throttle-based operation.

The electric bike 150 can include various components of the user interface 102, as may include input components and output components. For example, the input components can include throttle levers, mode selection switches, a touchscreen of a rider facing display, the pedals, and so forth. The output components can include rider-facing displays or other lights, speakers, RF transmitters, and so forth. The electric bike 150 can include sensors 152, such as pedal sensors 152 used to determine a force input by a rider of the electric bike 150 to determine an output power for the propulsion system 154 (e.g., a 1x or 3x multiplier, as may be selected according to a mode of operation or configuration parameter 124). The sensor 152 can include a location sensor 152 to generate location data indicative of a position of the electric bike 150. A location sensor 152 can include a global navigation satellite system receiver, or another sensor 152 configured to detect a beacon indicating a mode of operation associated with an area proximal to the beacon, or polling the electric bike 150 for its selected mode of operation. The sensor 152 can be integral to the electric bike 150, or otherwise coupled therewith. For example, the electric bike 150 can be configured to receive location data from another device, such as a mobile phone or wearable device operatively coupled with the electric bike 150.

The propulsion system 154 can include manually actuated pedals, and an electric motor configured to propel the electric bike 150. The electric motor can be coupled with a battery (and an inverter, in the case of an AC motor), battery management controller, and further associated components.

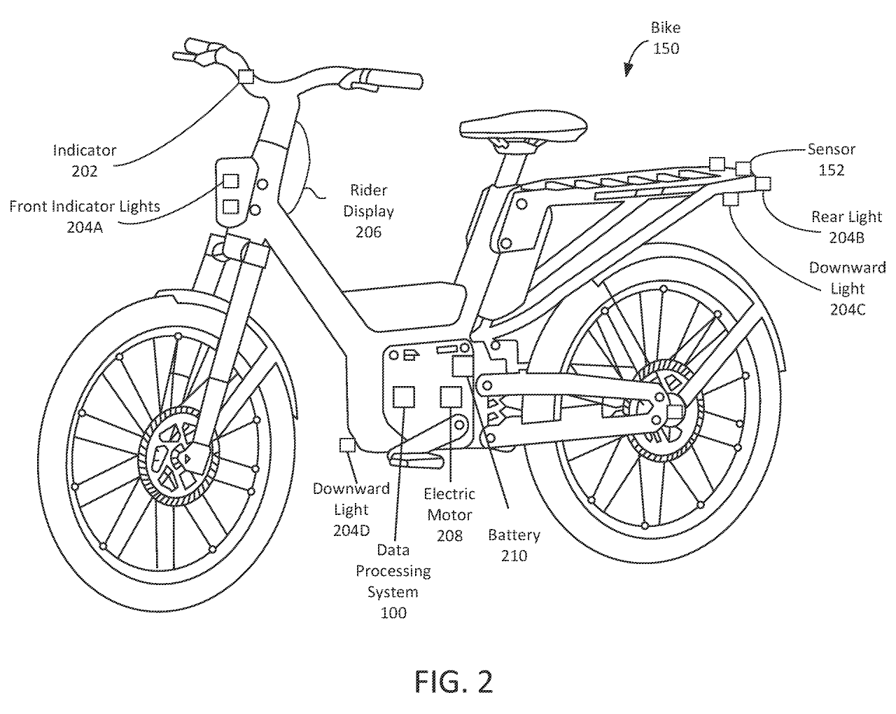

FIG. 2 depicts a perspective view of an electric bike 150 installed with at least one battery pack 210 electrically coupled with one or more components of a data processing system 100. Electric bikes 150 can include single rider bicycles, tandem bicycles, cargo bicycles, motor-assist bicycles, pedicabs, electric-assist bicycles, road bicycles, mountain bicycles, or unicycles, among others. The bike 150 can be fully electric or partially electric (e.g., pedal-powered) and further, the electric bike 150 can be fully autonomous, partially autonomous, semi-autonomous, or unmanned. The electric bike 150 can also be human operated or non-autonomous. A human operator or the rider of the bike 150 can sit on a saddle to operate the bike 150. The rider of the bike 150 can steer, grip, balance, or otherwise control the bike 150 using handlebars. The handlebars can include one or more indicators 202 to alert the rider of the bike of a condition. Indicators are sometimes referred to as output devices, without limitation. For example, the indicators 202 may include a lighting device, audio device, or a haptic system to provide various indications to the rider of the bike 150. Various indications, such as displays or presentations provided to a rider throughout the present disclosure, can refer to one or more visual, audio-visual, haptic, or other indications provided by one or more indicators 202.

The indicators 202 can be provided on the handlebars, as a part of a rider facing display 206, or otherwise. For example, the rider facing display 206 can provide one or more elements of a user interface 102, such as a graphical user interface 102 or an audio-based user interface 102. The user interface 102 can include, interface with, or otherwise utilize a touchscreen, keyboard, buttons, knobs, other user interface input devices 530 or display 535 depicted in FIG. 5, for example. Through an input device of the user interface 102, the rider of the bike 150 can select an operating mode, view a present or future operating mode, or control or view further components of the bike 150, among other actions.

The electric bike 150 can include a cruise control functionality or an adaptive cruise control functionality. For example, the electric bike 150 can be configured to autonomously drive, navigate, or propel the electric bike 150 when the electric bike 150 is traversing a straight path or road. To do so, the electric bike 150 can include sensors, control units, control functions, communication modules, or other components configured to achieve autonomous navigation, powered by an electric motor 208. For example, the electric bike 150 can include an accelerometer, gyroscope, or magnetometers that can provide data on the motion of the electric bike 150, orientation, location, or heading. The electric bike 150 can use this information for stabilization, path planning, or control functions, including the selection of a mode of operation. The electric bike 150 can include a path planning and navigation control function to generate routes for the electric bike 150, considering factors such as traffic conditions, road regulations, and rider preferences (e.g., configuration parameters 124).

The electric bike 150 can include a communications circuit to connect with external systems via a network. These modules include wireless communication technologies such as Wi-Fi, Bluetooth, and cellular connectivity. The electric bike 150 can integrate with a companion mobile application or a central control center, aiding riders to monitor and customize riding experience, receive real-time updates, and access various features. The electric bike 150 can use communication module or companion mobile application or control center to receive instructions for a route, and autonomously or semi-autonomously navigate the electric bike 150 along the route (e.g., select a mode of operation).

The bike 150 can include a frame to support various components of the bike 150, such as the handlebars, the indicators 202, a saddle, the sensors 152, the battery 210, and lights 204. The lights 204 can include one or more front indicator lights 204A, as can include a headlight, front turn signals, or further headlamps visible to a non-rider from the front of the bike 150 to indicate an operating mode. The lights 204 can include one or more rear indicator lights 204B, as can include a brake-light, rear turn signals, or further lights visible to a non-rider from the rear of the bike 150 to indicate an operating mode. Further, indicator lights 204 can be side mounted, or down-mounted, as may be visible to a rider or non-rider as illuminated on a riding surface (e.g., down-mounted lights, such as a rear down-light 204C or front downlight 204D can be provided as indirect lighting). The data processing system 100 can cause one or more of the indicator lights 204 to indicate an operating mode of the electric bike 150. For example, the data processing system 100 can cause the indicator lights 204 to provide at least one front-facing indicator light 204A to emit a color, pattern, or brightness corresponding with the selected mode of operation, or provide at least one rear-facing indicator lights 204B to emit a color, pattern, or brightness correspond to the selected mode of operation, as may be visible to a non-rider. The indicator visible to the non-rider can be visible to a rider, or a separate indictor can be provided for the rider (e.g., the rider facing display 206 or another indicator).

The bike 150 can include battery packs which can include batteries 210, battery modules, or battery cells power the electric bike 150. The battery 210 can be installed or placed within the bike 150. The battery 210 can include or connect with at least one busbar, e.g., a current collector element. For example, the busbar can include electrically conductive material to connect or otherwise electrically couple the battery 210 with other electrical components of the bike 150 to provide electrical power to various systems or components of the bike 150, such as the data processing system 100, or various further components configured to operate based on control signals generated by the data processing system 100. For example, these components can include various lights 204 and at least one electric motor 208 operatively coupled with at least one driven wheel of the electric bike 150. Although various illustrative examples of potential locations and types of lights and other components are depicted with regard to FIGS. 2, various components can be omitted, added, substituted, or otherwise modified. For example, a rear-facing light can be provided at a rear most portion of the bike, or on a seat post.

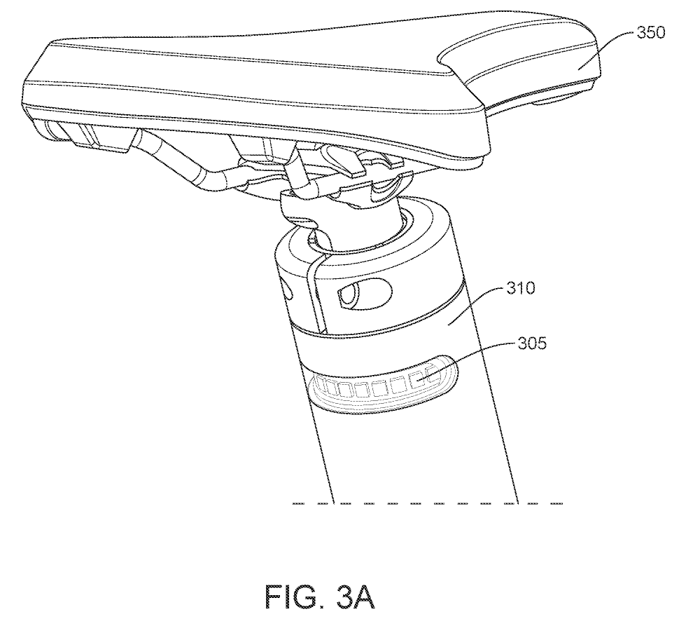

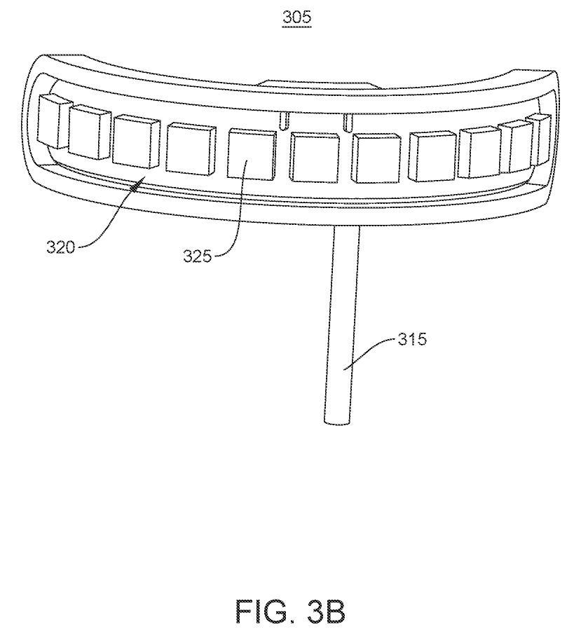

FIG. 3A depicts a detailed view of an electric bike 150, according to some aspects. For example, the detailed view includes a taillight assembly 305 configured to provide indications to a non-rider of the electric vehicle. The taillight assembly 305 can provide an indication of a presence of the bicycle, as a marker light or reflector. The taillight assembly 305 can provide an indication of an operating state of the electric bike. For example, the taillight assembly 305 can provide an indication of braking (e.g., providing a brighter or differently colored indications incident to operation of a regenerative or frictional brake system). The operating state of the electric bike 150 indicated by the taillight assembly 305 can include a (user selected or other) selected mode of operation of the electric bike 150. For example, the taillight assembly 305 can illuminate in different colors, patterns, brightnesses, or so forth to correspond to each of various modes of operation. According to the depicted illustrative example, the taillight assembly 305 is integrated into a seat post 310, under a saddle 350. However, various further indicators can provide visual or other indications of an operating state of the electric bike, as can include the selected or other assigned operating state. For example, any of various further lights of the electric bike 150 can provide an indication of the operating state according to a selected or other assigned mode, such as any of the lights depicted in FIG. 2.

FIG. 3B depicts a detailed view of the taillight assembly 305 of FIG. 3A. The taillight assembly 305 is shown omitting a cover (e.g., a translucent or semi-translucent cover) to better depict various light elements 320. The light elements 320 can further include separate lens covers 325, such as diffused lens covers 325. Each of the light elements 320 can include one or more light emitting diodes (LEDs). For example, the light elements 320 can include an additive color array of LEDs actuatable to provide a selected color to correspond to an assigned mode of operation of the electric bike 150 (e.g., a red, green, and blue (RGB) trichromatic emitter array). For example, a cable assembly 315 can operatively couple the light elements 320 with other components of the data processing system 100. The various light elements 320 can be individually addressable, such that one or more of the light elements 320 can provide an indication of the assigned mode of operation while others of the light elements 320 indicate another operating condition of the electric bike. For example, one or more light elements 320 can provide a flashing light, a blue light, a yellow light, or a green light while others of the light elements 320 can provide an indication of braking, act as a marker light, or so forth. Some electric bikes 150 can include different indications on different lights, as may ease distinguishing the data provided by the various lights.

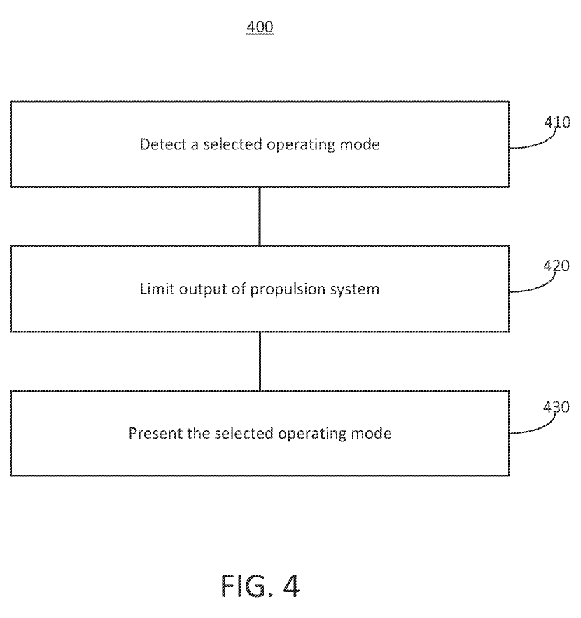

FIG. 4 depicts a method 400 of indicating an operating mode of an electric bike 150 is provided, according to some aspects. The method 400 can be performed by one or more systems or components depicted in FIGS. 1-3, including the data processing system 100. For example, the method 400 can be performed by one or more controllers of an electric bike 150, having a memory device communicatively coupled therewith (e.g., including processing circuity, such as a processor of FIG. 5). The various operations of the method 400 can include ACTs provided henceforth, and can further duplicate, or adapt various aspects described throughout the present disclosure.

The method 400 can include an ACT of detecting a selected operating mode of various potential operating modes of an electric bike 150 (ACT 410). The selected operating mode can be received from an input device of the bike 150 or by a data processing system 100 selecting the selecting operating mode using location data. The location data can include location data for the electric bike 150 included in sensor data, as can be compared to one or more geofenced regions. For example, if the electric bike is not in a geofenced region, the data processing system 100 can provide the selected mode as received as a user input from the input device. If the electric bike 150 is in a geofenced region, the data processing system 100 can detect a difference between a user selected operating mode and another operating mode associated with the location of the bike, and output one of the operating modes according to a corresponding configuration parameter 124.

The method 400 can include an ACT of generating a first control signal to limit an output of the propulsion system of the electric bike 150 (ACT 420). For example, the data processing system 100 can, in response to detecting the difference, generate control signals to cause an output of the propulsion system 154 to be limited. The control signals can automatically change a selected mode of operation, or prompt a user to make the change manually.

The method 400 can include an ACT of generating a second control signal to cause a presentation of the selected mode of operation (e.g., using a taillight or headlight of the electric bike) (ACT 430). The indication of the mode of operation can be in addition to another indication using a rider facing display 206. If the electric bike 150 is not in a geofenced region, the selected mode can be provided as a user selected mode indicated via the user input or another mode associated with the geofenced location (e.g., according to configuration parameters 124).

FIG. 5 depicts an example block diagram of an example computer system 500. The computer system or computing device 500 can include or be used to implement a data processing system 100 or its components. The computing system 500 includes at least one bus 505 or other communication component for communicating information and at least one processor 510 or processing circuit coupled to the bus 505 for processing information. The computing system 500 can also include one or more processors 510 or processing circuits coupled to the bus for processing information. The computing system 500 also includes at least one main memory 515, such as a random-access memory (RAM) or other dynamic storage device, coupled to the bus 505 for storing information, and instructions to be executed by the processor 510. The main memory 515 can be used for storing information during execution of instructions by the processor 510. The computing system 500 may further include at least one read only memory (ROM) 520 or other static storage device coupled to the bus 505 for storing static information and instructions for the processor 510. A storage device 525, such as a solid-state device, magnetic disk or optical disk, can be coupled to the bus 505 to persistently store information and instructions.

The computing system 500 may be coupled via the bus 505 to a display 535, such as a liquid crystal display, or active-matrix display, or LED for displaying information to a user such as a rider or non-rider of the electric bike 150. Some computing systems 500 can include separate displays for separate users (e.g., a head unit for the rider or a taillight for a non-rider). An input device 530, such as a button or voice interface may be coupled to the bus 505 for communicating information and commands to the processor 510. The input device 530 can include a touch screen display 535. The input device 530 can also include a cursor control, such as a mouse, a trackball, or cursor direction keys, for communicating direction information and command selections to the processor 510 and for controlling cursor movement on the display 535.

The processes, systems and methods described herein can be implemented by the computing system 500 in response to the processor 510 executing an arrangement of instructions contained in main memory 515. Such instructions can be read into main memory 515 from another computer-readable medium, such as the storage device 525. Execution of the arrangement of instructions contained in main memory 515 causes the computing system 500 to perform the illustrative processes described herein. One or more processors in a multi-processing arrangement may also be employed to execute the instructions contained in main memory 515. Hard-wired circuitry can be used in place of or in combination with software instructions together with the systems and methods described herein. Systems and methods described herein are not limited to any specific combination of hardware circuitry and software.

Although an example computing system has been described in FIG. 5, the subject matter including the operations described in this specification can be implemented in other types of digital electronic circuitry, or in computer software, firmware, or hardware, including the structures disclosed in this specification and their structural equivalents, or in combinations of one or more of them.

Some of the description herein emphasizes the structural independence of the aspects of the system components or groupings of operations and responsibilities of these system components. Other groupings that execute similar overall operations are within the scope of the present application. Modules can be implemented in hardware or as computer instructions on a non-transient computer readable storage medium, and modules can be distributed across various hardware or computer-based components.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C#, PROLOG, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

For example, descriptions of positive and negative electrical characteristics may be reversed. Further relative parallel, perpendicular, vertical or other positioning or orientation descriptions include variations within +/-10% or +/-10 degrees of pure vertical, parallel or perpendicular positioning. References to “approximately,” “substantially” or other terms of degree include variations of +/-10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. An electric bike, comprising:
an input device to receive a selection of one of a plurality of modes of operation for the electric bike;
an output device to provide a plurality of indications corresponding to the plurality of modes of operation;
an electric motor to propel the electric bike; and
one or more processors, coupled with memory, to, in response to a receipt of the selected mode of operation from the input device:
operate the electric motor in the selected mode of operation; and
cause the output device to output one of the plurality of indications corresponding to the selected mode of operation.

2. The electric bike of claim 1, comprising:
the input device including a switch actuatable by a rider of the electric bike;
the output device including a taillight of the electric bike; and
the plurality of indications including a plurality of colors of the taillight.

3. The electric bike of claim 1, comprising the plurality of modes of operation to include:
a first mode of operation to inhibit pedal-assisted operation of the electric motor above a first speed and inhibit throttle-controlled operation of the electric motor below the first speed;
a second mode of operation to permit throttle-controlled operation of the electric motor below the first speed; and
a third mode of operation to permit pedal-assisted operation of the electric motor above the first speed.

4. The electric bike of claim 1, comprising:
a sensor to detect a location of the electric bike,
wherein the one or more processors are to:
determine a mode of operation associated with the location; and
present an indication of the determined mode of operation.

5. The electric bike of claim 1, comprising:
a sensor to detect a location of the electric bike,
wherein the one or more processors are to:
determine a mode of operation associated with the location; and
automatically select the determined mode of operation.

6. The electric bike of claim 1, comprising the one or more processors to:
receive, from a mobile device, a selection of a configuration parameter for the operation of the electric bike; and
automatically select the determined mode of operation based on a detected location of the electric bike and the configuration parameter.

7. The electric bike of claim 1, comprising:
the output device including a transmitter to broadcast a radio-frequency broadcast signal indicating the selected mode of operation.

8. The electric bike of claim 1, comprising the one or more processors to:
determine a route for the electric bike; and
provide, prior to entering a geofenced region corresponding to a mode of operation, an indication of the corresponding mode of operation.

9. The electric bike of claim 1, comprising the one or more processors to:
slew a torque output of the electric motor while transitioning from a first mode of operation of the plurality of modes of operations to a second mode of operation of the plurality of modes of operation.

10. A system comprising:
one or more processors, coupled with memory, to:
receive, from an input device, a selection of one of a plurality of modes of operation for an electric bike;
compare an operating state of the electric bike to a threshold;
generate a first control signal to limit torque generated by an electric motor of a propulsion system of the electric bike based on the comparison; and
generate a second control signal to cause a presentation of the selected mode of operation to a non-rider of the electric bike.

11. The system of claim 10, comprising:
the input device including a mechanical switch of the electric bike; and
the presentation of the selected mode of operation includes an actuation of a visual indicator of the electric bike.

12. The system of claim 10, comprising the plurality of modes of operation to include:
a first mode of operation to inhibit pedal-assisted operation of the propulsion system above a first speed and inhibit throttle-controlled operation of the propulsion system;
a second mode of operation to permit throttle-controlled operation of the propulsion system below the first speed; and
a third mode of operation to permit pedal-assisted operation of the electric motor above the first speed.

13. The system of claim 10, comprising the controller to:
receive, from a location sensor, a position of the electric bike;
compare the position to a plurality of geofenced regions to detect an overlap with one of the geofenced regions; and
responsive to the detection of the overlap, automatically change the selected mode of operation.

14. The system of claim 10, comprising the controller to:
receive an indication of a route for the electric bike;
compare the route to a plurality of geofenced regions to detect an overlap with one of the geofenced regions;
determine a mode of operation corresponding to the one of the geofenced regions is different from the selected mode of operation; and
present an indication of the difference.

15. The system of claim 10, comprising the controller to:
receive, from a location sensor, a position of the electric bike;
compare the position to a plurality of geofenced regions to detect a proximity of the electric bike to one of the geofenced regions; and
responsive to a detection of the proximity, present an indication of a mode of operation corresponding to the one of the geofenced regions.

16. The system of claim 10, comprising the controller to:
present the indication of the selected mode of operation using a visual indicator for a rider of the electric bike different from a taillight of the electric bike used to provide the presentation to the non-rider.

17. A method comprising:
detecting, by one or more processors and memory coupled with a bike, a selected operating mode of a plurality of operating modes; and
responsive to the detection, generating:
a first control signal to limit an output of a propulsion system of the bike; and
a second control signal to cause a presentation of the selected mode of operation using a taillight or headlamp of the bike.

18. The method of claim 17, comprising:
receiving sensor data comprising location data for the bike; and
selecting the selected operating mode from the plurality of operating modes using the location data.

19. The method of claim 17, comprising:
detecting, using location data for the bike, a difference between the selected operating mode and another operating mode associated with a location of the bike; and
responsive to the detection of the difference, generating:
a third control signal to limit an output of a propulsion system of the bike below a level for the selected operating mode; and
a fourth control signal to cause a presentation of the other mode of operation using the taillight or headlamp of the bike.

20. The method of claim 17, comprising the plurality of modes of operation to include:
a first mode of operation to inhibit pedal-assisted operation of the propulsion system above a first speed and inhibit throttle-controlled operation of the propulsion system;
a second mode of operation to permit the throttle-controlled operation of the propulsion system below the first speed; and
a third mode of operation to permit pedal-assisted operation of the propulsion system above the first speed.
